(19) United States
(12) Patent Application Publication
(10) Pub. No.: US 2024/0061492 A1
(43) Pub. Date: Feb. 22, 2024

(54) PROCESSOR PERFORMING DYNAMIC VOLTAGE AND FREQUENCY SCALING, ELECTRONIC DEVICE INCLUDING THE SAME, AND METHOD OF OPERATING THE SAME

(71) Applicant: Samsung Electronics Co., Ltd., Suwon-si (KR)

(72) Inventors: Bumgyu PARK, Suwon-si (KR); Jonglae PARK, Suwon-si (KR); Choonghoon PARK, Suwon-si (KR); Daeyeong LEE, Suwon-si (KR); Jiyoung LEE, Suwon-si (KR); Hyunwook JOO, Suwon-si (KR)

(73) Assignee: Samsung Electronics Co., Ltd., Suwon-si (KR)

(21) Appl. No.: 18/180,427

(22) Filed: Mar. 8, 2023

(30) Foreign Application Priority Data
Aug. 18, 2022 (KR) 10-2022-0103194

(51) Int. Cl. G06F 1/3234; G06F 1/20

(52) U.S. Cl. CPC G06F 1/3275; G06F 1/206

(57) ABSTRACT

A processor includes a central processing unit (CPU) configured to drive a dynamic voltage and frequency scaling (DVFS) module, a memory hierarchy configured to store data for an operation of the CPU, and an activity monitoring unit (AMU) configured to generate microarchitecture information by monitoring performance of the CPU or monitoring traffic of a system bus connected to the memory hierarchy. The DVFS module is configured to determine a layer within the memory hierarchy in which a memory stall occurs using the microarchitecture information, and to increase a frequency in response to the determined layer being accessed.

### CROSS-REFERENCE TO RELATED APPLICATION(S)

This application claims benefit of priority to Korean Patent Application No. 10-2022-0103194, filed on Aug. 18, 2022 in the Korean Intellectual Property Office, the disclosure of which is incorporated herein by reference in its entirety.

### BACKGROUND

Example Embodiment disclosed herein relate to a processor performing dynamic voltage and frequency scaling (DVFS), an electronic device including the same, and a method of operating the same.

In general, in order to increase multi-thread performance in a mobile environment, as the number of cores increases, and master intellectual properties (IPs) specialized for various multimedia scenarios are continuously added into an application processor, competition entities are diversifying. Accordingly, the application processor performs a dynamic voltage and frequency scaling (DVFS) operation to adjust a frequency/voltage in the application processor, thereby controlling performance and a degree of power consumed.

### SUMMARY

Some example embodiments of the present disclosure provide a novel processor performing dynamic voltage and frequency scaling (DVFS), an electronic device including the same, and a method of operation the same.

Some example embodiments of the present disclosure provide a processor performing DVFS to reduce power consumption, an electronic device including the same, and a method of operating the same.

Some example embodiments of the present disclosure provide a processor performing DVFS to improve performance, an electronic device including the same, and a method of operating the same.

According to an example embodiment of the present disclosure, there is provided a processor including a central processing unit (CPU) configured to drive a DVFS module, a memory hierarchy configured to store data for an operation of the CPU, and an activity monitoring unit (AMU) configured to generate microarchitecture information by monitoring performance of the CPU or monitoring traffic of a system bus connected to the memory hierarchy. The DVFS module may be configured to determine a layer within the memory hierarchy in which a memory stall occurs using the microarchitecture information, and to increase a frequency in response to the determined layer being accessed.

According to another example embodiment of the present disclosure, there is provided a method of operating a processor, the method including monitoring, by a performance monitoring unit or a bus traffic monitoring unit, microarchitecture information, and controlling frequencies of a CPU, a cache memory, or a memory device using the microarchitecture information, monitoring, by the performance monitoring unit, performance of the CPU, monitoring, by the bus traffic monitoring unit, traffic of a system bus between the cache memory and the memory device.

According to another example embodiment of the present disclosure, there is provided an electronic device including a processor, and a memory device connected to the processor. The processor may include CPU configured to drive a DVFS module, a cache memory configured to temporarily store data for an operation of the at least one CPU, a memory interface circuit configured to transmit data of the cache memory to the memory device through a system bus, and an AMU configured to monitor performance of the at least one CPU, or monitor traffic of the system bus. The DVFS module may be configured to collect microarchitecture information from the AMU, and control a frequency of at least one of the at least one CPU, the cache memory, and the memory interface circuit using the microarchitecture information.

According to another example embodiment of the present disclosure, there is provided a method of operating a processor, the method including collecting microarchitecture information from an AMU, determining a frequency of a CPU using the microarchitecture information, and determining a frequency of a memory hierarchy using the microarchitecture information.

According to another example embodiment of the present disclosure, there is provided an electronic device including an AMU configured to generate microarchitecture information by monitoring performance or monitoring bus traffic, a CPU configured to generate clock control information by executing a DVFS module based on the microarchitecture information, a cache memory configured to store data for an operation of the CPU, a memory device configured to store data of the cache memory through a system bus, and a clock management unit (CMU) configured to change a frequency of at least one of the CPU, the cache memory, and the memory device, based on the clock control information.

According to some example embodiments, a frequency for each memory hierarchy may be controlled based on microarchitecture information, thereby efficiently managing the frequency while reducing power consumption.

### BRIEF DESCRIPTION OF DRAWINGS

The above and other features and advantages of the present inventive concepts will be more clearly understood from the following detailed description, taken in conjunction with the accompanying drawings, in which:

FIG. 1 is a diagram illustrating an electronic device according to an example embodiment;

FIG. 2 is an example diagram illustrating a dynamic voltage and frequency scaling (DVFS) module according to an example embodiment of the present disclosure;

FIG. 3 is a schematic diagram illustrating a DVFS operation for each memory hierarchy according to an example embodiment of the present disclosure;

FIG. 4 is an example diagram illustrating a DVFS operation of a processor according to an example embodiment of the present disclosure;

FIGS. 5A, 5B, and 5C are schematic diagrams illustrating an operation of an activity monitoring unit (AMU);

FIG. 6 is a diagram illustrating an MH-DVFS operation according to an example embodiment of the present disclosure;

FIG. 7 is a diagram illustrating a result of comparing a conventional DVFS method with an MH-DVFS according to some example embodiments with respect to a web browsing scenario;

FIG. 8 is a diagram illustrating a comparison between average values of a memory stall per cycle (MSPC) and an instruction per cycle (IPC) of a processor according to an example embodiment of the present disclosure;

FIG. 9 is a diagram illustrating a comparison in power consumptions of a processor according to an example embodiment of the present disclosure;

FIG. 10 is an example diagram illustrating distribution of a memory stall per instruction (MPI) depending on an IPC in a web browsing scenario;

FIG. 11A is a diagram illustrating a memory stall per cycle depending on a frequency of an outer cache (OC), and FIG. 11B is a diagram illustrating a memory stall per cycle depending on a frequency of a memory (MEM);

FIG. 12 is an example diagram illustrating a current consumption proportion occupied by each of a central processing unit (CPU) and a memory hierarchy in a web browsing scenario;

FIG. 13 is an example diagram illustrating a method of operating a processor according to an example embodiment of the present disclosure;

FIG. 14 is an example diagram illustrating a method of operating a processor according to another example embodiment of the present disclosure;

FIG. 15 is a ladder diagram illustrating an operation of an electronic device according to an example embodiment of the present disclosure;

FIG. 16 is a ladder diagram illustrating a multi-core system according to an example embodiment of the present disclosure;

FIG. 17 is a diagram illustrating an electronic device according to an example embodiment of the present disclosure;

FIG. 18 is a diagram illustrating a neural network computing system according to an example embodiment of the present disclosure; and

FIG. 19 is an example diagram illustrating a hierarchical structure of a neural network computing system according to an example embodiment of the present disclosure.

### DETAILED DESCRIPTION

Hereinafter, example embodiments of the present disclosure will be described clearly and specifically such that a person skilled in the art easily could carry out example embodiments using the drawings.

In general, a mobile device may have limited battery capacity. Thus, it may be necessary to use an efficient dynamic voltage and frequency scaling (DVFS) technique capable of minimizing power consumption while satisfying performance of various types of applications. In a general DVFS method, a frequency may be selected in proportion to execution time of a central processing unit (CPU). In such a DVFS method, in general, a CPU may properly operate when performing a CPU intensive job, but the CPU may operate inefficiently when performing a memory intensive job. This may be because, when performing the memory intensive job, memory stall time (the CPU is in a standby state during memory access) may take a larger proportion of the total CPU execution time than time in which the CPU actually operates. In such a DVFS method, a frequency may be selected based on the total execution time despite a small amount of actual CPU execution time, such that the CPU may operate at a frequency higher than is required for performance, resulting in unnecessary power consumption. In addition, even when a memory stall persists, the persisting memory stall may not be perceived, causing degradation in CPU performance.

A processor, electronic device including the same, and method of operating the same according to an example embodiment of the present disclosure may hierarchically control, based on microarchitecture information, frequencies of a CPU, an outer cache, and a memory. Here, the microarchitecture information may include instruction per cycle (IPC) information or memory stall per cycle (MSPC) information. Accordingly, the processor, an electronic device including the same, and a method of operating the same according to an example embodiment of the present disclosure may reduce unnecessary CPU power consumption and minimize memory stalls.

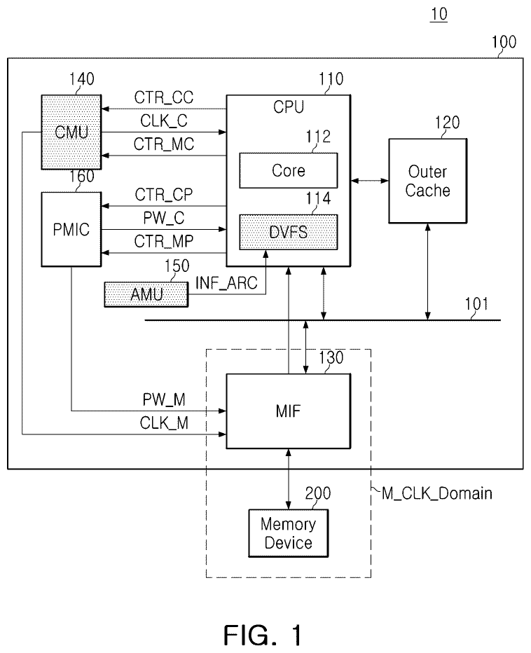

FIG. 1 is a diagram illustrating an electronic device 10 according to an example embodiment. Referring to FIG. 1, the electronic device 10 may include a processor 100 and a memory device 200. The electronic device 10 illustrated in FIG. 1 may be used as various types of data processing devices. For example, the electronic device 10 may be a mobile device employing the processor 100. In addition, the electronic device 10 is a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), a wearable computer, an Internet of Things (IoT) device, an Internet of Everything (IoE) device, or an e-book.

The electronic device 10 may include various types of memory devices 200. For example, the memory device 200 may be implemented as various types of memory devices. In an example embodiment, the memory device 200 may be implemented as a dynamic random access memory (DRAM) such as a double data rate synchronous DRAM (DDR SDRAM), a low power double data rate (LPDDR), an SDRAM, a graphics double data rate (GDDR), an SDRAM, and a rambus DRAM (RDRAM). In addition, the memory device 200 may be implemented as at least one of a flash memory, a phase-change RAM (PRAM), a magnetoresistive RAM (MRAM), a resistive RAM (RRAM), and a ferroelectric RAM (FeRAM).

The processor 100 may be implemented as a system on chip (SoC). The SoC may include a system bus to which a protocol having a predetermined (or alternatively, desired) standard bus specification is applied. The SoC may include various intellectual properties (Ips) connected to the system bus. As a specification of the system bus, an advanced microcontroller bus architecture (AMBA) protocol of an advanced RISC machine (ARM) company may be applied. Types of a bus using the AMBA protocol may include advanced high-performance bus (AHB), advanced peripheral bus (APB), advanced eXtensible interface (AXI), AXI4, and AXI coherency extensions (ACE). In addition, other types of protocols such as uNetwork of SONICs Inc., CoreConnect of IBM, and Open Core Protocol of OCP-IP may be applied.

The processor 100 may include a CPU 110, a cache memory (outer cache) 120, a memory interface circuit (MIF) 130, a clock management unit (CMU) 140, an activity monitoring unit (AMU) 150, and a power management integrated circuit (PMIC) 160.

The CPU 110 may include at least one core 112 and a DVFS module 114. The core 112 may be an independent processor. The core 112 may execute instructions. In addition, the core 112 may load the DVFS module 114 for performing a DVFS operation from the cache memory 120 and execute the loaded DVFS module 114. Hereinafter, a module may refer to hardware capable of performing a function and operation corresponding to a name thereof or may refer to a computer program code capable of performing a specific function and operation. However, the example embodiments of the present disclosure are not limited thereto and may refer to an electronic recording medium equipped with a computer program code capable of performing a specific function and operation, for example, a processor. That is, the module may refer to a functional or structural combination of hardware for realizing the present inventive concepts or software for driving the hardware.

In addition, when an L2 cache miss occurs while processing an instruction, the core 112 may temporarily stop a computational operation and access the memory interface circuit 130 to write or read out data necessary for processing an instruction in or from the memory device 200. Hereinafter, an operation of accessing, by the core 112, the memory interface circuit 130 may include an operation of accessing, by the core 112, the memory device 200. A computational operation for processing an instruction being stopped and the memory interface circuit 130 being accessed by the core 112 may be defined as a memory access stall.

The DVFS module 114 may determine operating states of various functional blocks in the processor 100 and may provide control signals for adjusting frequencies or voltages of the various functional blocks depending on a determination result to the CMU 140 or the PMIC 160. In an example embodiment, the DVFS module 114 may adjust a frequency and voltage of a clock signal provided to the CPU 110. Separately, the DVFS module 114 may adjust a frequency and voltage of a clock signal provided to the memory interface circuit 130.

In addition, the DVFS module 114 may perform the DVFS operation in consideration of a cycle of a memory access stall period in which the core 112 substantially does not perform a computational operation. The term “cycle” used hereinafter may indicate time of a predetermined (or alternatively, desired) period. The core 112 or the memory interface circuit 130 may be changed depending on a frequency of the clock signal, a basis for an operation of the core 112 or the memory interface circuit 130. For example, a cycle value having “n” may correspond to time corresponding to n periods of the clock signal, a basis of an operation of the core 112 or the memory interface circuit 130. In an example embodiment, the DVFS module 114 may correct, based on information on a memory access stall cycle, a core active cycle of a period in which the core 112 performs an operation of processing an instruction within a first period, such that the core active cycle may include only a cycle in which the core 112 substantially performs a computational operation. For example, the information on a memory access stall cycle may include a memory access stall cycle. In addition, the core active cycle may be corrected by subtracting the memory access stall cycle from the core active cycle.

In addition, the DVFS module 114 may compute a load of the core 112 using the corrected core active cycle and a core idle cycle of a period in which the core 112 is in an idle state within the first period. The DVFS module 114 may provide, based on the load of the core 112, a clock control signal CTR_CC to the CMU 140 or a power control signal CTR_CP to the PMIC 160.

In addition, the DVFS module 114 may perform the DVFS operation on the memory interface circuit 130 separately from the CPU 110. The DVFS module 114 may collect a memory active cycle M_Tact from the memory interface circuit 130. The memory active cycle M_Tact may indicate a cycle in which the memory interface circuit 130 and the memory device 200 included in a memory clock domain M_CLK_Domain perform, in response to a predetermined (or alternatively, desired) request received from the CPU 110 or another master IP, a memory operation. In an example embodiment, in a second period, the memory active cycle M_Tact may include a data transaction cycle of a period in which the memory interface circuit 130 performs, in response to the request from the CPU 110 or another master IP, a data input/output operation using the memory device 200 and a ready operation cycle of a period in which the memory interface circuit 130 performs, in response to the request from the CPU 110 or another master IP, an operation necessary for the data input/output operation.

In addition, the DVFS module 114 may compute a load for the memory interface circuit 130 by considering the period necessary to perform the data input/output operation using the memory device 200 in addition to the data transaction cycle corresponding to a bandwidth of data input and output through the memory interface circuit 130 and the memory device 200. The DVFS module 114 may compute, based on the collected memory active cycle M_Tact, a load of the memory clock domain M_CLK_Domain including the memory interface circuit 130 and the memory device 200, and may perform, on the computed load, the DVFS operation on the memory interface circuit 130. Although not illustrated in FIG. 1, since the memory interface circuit 130 and the memory device 200 are included in the same memory clock domain M_CLK_Domain, the memory device 200 may receive, as a result of performing the DVFS operation, a clock signal CLK_M the same as that of the memory interface circuit 130, and may also receive power PW_M the same as that of the memory interface circuit 130.

In addition, the DVFS module 114 may receive, from the AMU 150, microarchitecture information INF_ARC, and may perform a hierarchical DVFS operation for each IP using the microarchitecture information INF_ARC. Here, the microarchitecture information INF_ARC may include information related to usages of the cache memory 120 and the memory interface circuit 130 or traffic of a bus 101. The DVFS module 114 may monitor the microarchitecture information INF_ARC on the fly or in real time, and may control a frequency/voltage for each IP depending on a result thereof.

The cache memory 120 may be implemented to temporarily store a program, data, or instruction. The cache memory 120 may be implemented as a volatile memory or a non-volatile memory. The cache memory 120 may store data necessary for an operation of the CPU 110.

The memory interface circuit 130 may be implemented to transmit data of the cache memory 120 to the memory device 200 through the system bus 101. The memory interface circuit 130 may access the memory device 200 to write data in the memory device 200 or read out data from the memory device 200. The memory interface circuit 130 may interface with the memory device 200, and may provide, to the memory device 200, various commands such as a write command, a read command, and the like in relation to the memory operation. Accordingly, the memory interface circuit 130 and the memory device 200 may be included in the same memory clock domain M_CLK_Domain, and the memory interface circuit 130 and the memory device 200 in the same memory clock domain M_CLK_Domain may perform, based on a clock signal having the same frequency, the memory operation.

The CMU 140 may be implemented to provide, in response to the clock control signal CTR_CC, a clock signal CLK_C having a scaled frequency to the CPU 110.

The AMU 150 may be implemented to generate the microarchitecture information INF_ARC by monitoring CPU performance or monitoring bus traffic. The AMU 150 may monitor a usage between the cache memory 120 and the memory interface circuit 130. In addition, the AMU 150 may monitor bus traffic for at least one memory channel.

The PMIC 160 may be implemented to provide, in response to the power control signal CTR_CP, power PW_C having a scaled level to the CPU 110. Although the PMIC 160 illustrated in FIG. 1 is implemented within the processor 100, the PMIC 160 may be implemented outside the processor 100. In addition, the processor 100 may include a power management unit instead of the PMIC 160 to control power provided to functional blocks within the processor 100.

The processor 100 may include a peripheral block connected to the bus 101. In an example embodiment, the peripheral block may include various types of functional blocks such as an input/output interface block (10 interface block) communicating with at least one master IP, a universal serial bus (USB) host block, a USB slave block, and the like.

The electronic device 10 according to an example embodiment of the present disclosure may determine, based on the microarchitecture information INF_ARC, a layer in which a memory stall occurs within a memory hierarchy, and may increase a frequency/voltage when the determined memory stall layer is accessed. Accordingly, the electronic device 10 according to some example embodiments of the present disclosure may secure optimal performance while reducing power consumption by applying the DVFS technique for each memory hierarchy.

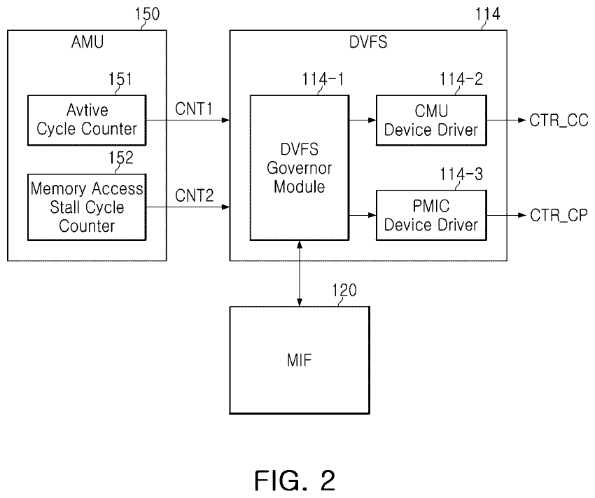

FIG. 2 is an example diagram illustrating the DVFS module 114 according to an example embodiment of the present disclosure. Referring to FIG. 2, the DVFS module 114 may include a DVFS manager 114-1, a CMU device driver 114-2, and a PMIC device driver 114-3. The DVFS module 114 may collect, from the AMU 150, first count information CNT1 including a core active cycle and second count information CNT2 including a memory access stall cycle.

The DVFS manager 114_1 may control an overall DVFS operation. In an example embodiment, the DVFS manager 114_1 may collect, from the AMU 150, the first count information CNT1 and the second count information CNT2 including the core active cycle, and may collect a threshold CPI TH_CPI from the cache memory 120. The DVFS manager 114_1 may use the threshold CPI TH_CPI to generate information on a memory access stall cycle of a core. Here, the threshold CPI TH_CPI may measure an active cycle required (or alternatively, desired) for the core to process a plurality of instructions that do not need an access operation on the memory interface circuit 130, and may be a value obtained by converting the active cycle into a cycle required (or alternatively, desired) to process one instruction. That is, the DVFS manager 114 may derive a ratio of the memory access stall cycle included in the core active cycle using the threshold CPI TH_CPI. In an example embodiment, the information on the memory access stall cycle generated by the DVFS manager 114_1 may include a memory access stall cycle per instruction (SPI).

In addition, the DVFS manager 114_1 may generate a corrected core active cycle including only a cycle in which the core performs a computational operation by subtracting the memory access stall cycle from the core active cycle using the first count information CNT1 and the second count information CNT2. The DVFS manager 114_1 may compute an accurate load of the core using a ratio between the core active cycle and a sum of the corrected core active cycle and the core idle cycle. The DVFS manager 114_1 may control, based on the load of the core, each of a CMU device driver 114_2 and a PMIC device driver 114_3. The DVFS module 114_1 may perform the efficient DVFS operation by accurately counting and generating the memory access stall cycle included in the core active cycle, and deriving the accurate load of the core using the memory access stall cycle.

In addition, the DVFS manager 114-1 may include an MH-DVFS performing the optimal DVFS operation for each memory hierarchy depending on a memory stall using architecture information, for example, the first and second count information CNT1 and CNT2.

The AMU 150 may be implemented to measure core performance parameters or measure bus traffic. The AMU 150 may include an active cycle counter 151 and a memory access stall cycle counter 152. The active cycle counter 151 may measure the core active cycle by counting time of a period in which the core performs an operation for processing instructions during a first period. The first period may be a manager window set by the DVFS manager 114_1. Here, a length of the first period may be changed differently, depending on a DVFS operation method for the core. The memory access stall cycle counter 152 may measure the memory access stall cycle by counting a period in which the core accesses the memory interface circuit 130 within the core active cycle.

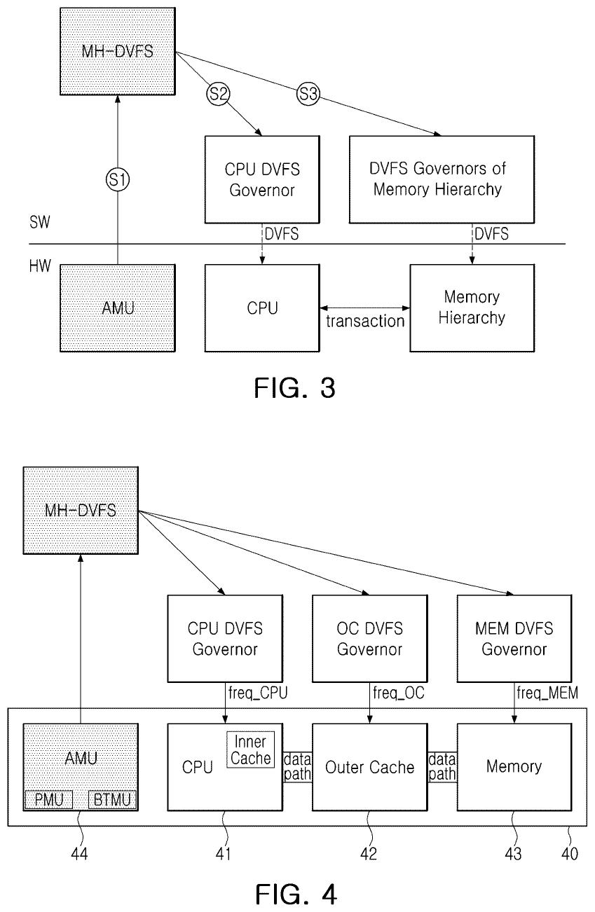

FIG. 3 is a schematic diagram illustrating a DVFS operation for each memory hierarchy according to an example embodiment of the present disclosure. As illustrated in FIG. 3, the processor 100 may hierarchically control a frequency of a CPU-Memory path depending on a degree of a memory stall, thereby rapidly resolving the memory stall and removing unnecessary CPU power consumption.

The processor 100 may rapidly resolve the memory stall by increasing a frequency of an element that is a bottleneck in the CPU-Memory path. In addition, when the memory stall is high and a CPU throughput is low, the processor 100 may decrease a frequency of the CPU to remove unnecessary CPU power consumption.

The MH-DVFS may determine, based on the microarchitecture information INF_ARC collected from the AMU, a layer in which a memory stall occurs within a memory hierarchy (S1). The MH-DVFS may set a frequency of a DVFS domain, affecting when the layer in which the memory stall occurs is accessed, to be increased (S2). In this case, a frequency of each domain to be set may be determined as a combination for achieving lowest energy. Conversely, when the CPU has low productivity (low IPC and low MSPC), the MH-DVFS may set the frequency of the CPU to be decreased (S3).

FIG. 4 is an example diagram illustrating a DVFS operation of a processor 40 according to an example embodiment of the present disclosure. An MH-DVFS may perform a memory hierarchy DVFS operation. A CPU DVFS manager may determine an operating frequency of a CPU. An OC DVFS manager may determine an operating frequency of an outer cache. A MEM DVFS manager may determine an operating frequency of a memory. An AMU 44 may provide microarchitecture information of a CPU 41. The AMU 44 may include a PMU and a BTMU. The CPU 41 may be a H/W device processing a job. An inner cache may be a cache memory positioned within the CPU 41. An outer cache 42 may be a cache memory positioned between the CPU 41 and a memory device 43. The outer cache 42 may be capable of independent frequency operation. The memory device 43 may be capable of independent frequency operation.

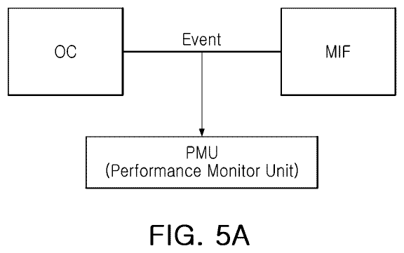

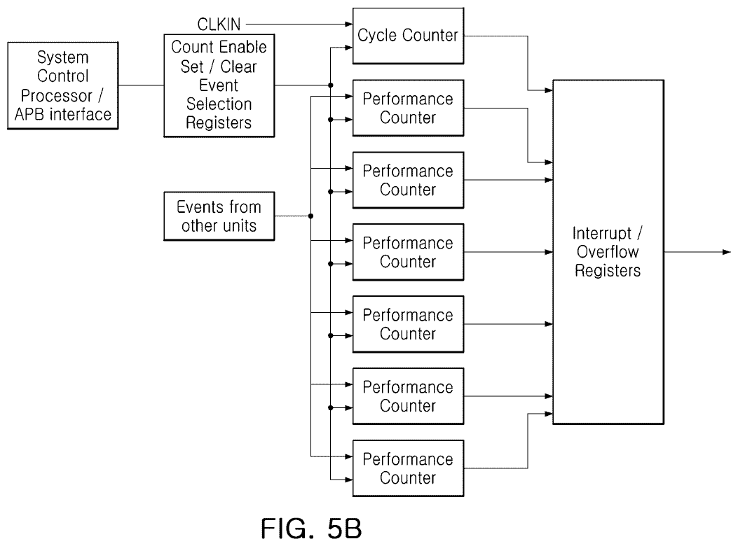

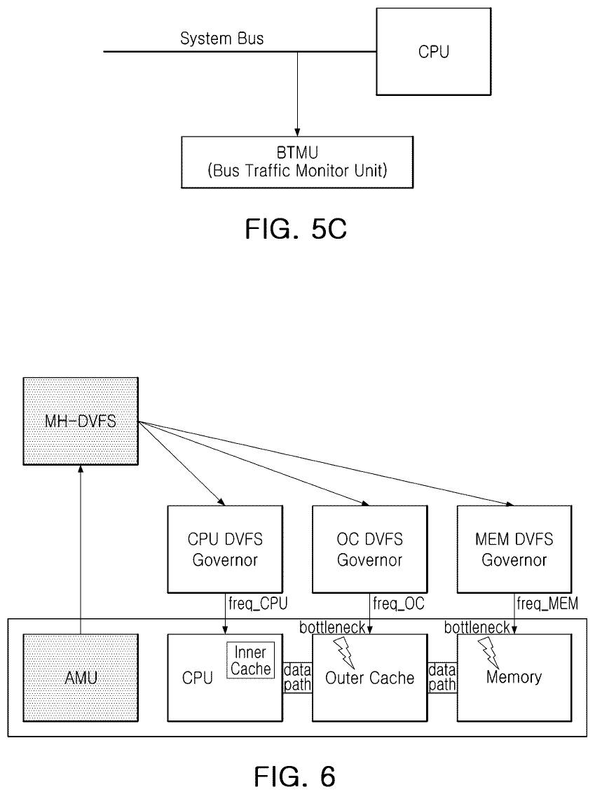

FIGS. 5A, 5B, and 5C are schematic diagrams illustrating an operation of an AMU.

As illustrated in FIG. 5A, the PMU may monitor an event between an OC and an MIF 130. As illustrated in FIG. 5B, the PMU may include registers selecting a count activation setting/clear event, a plurality of counters counting depending on an event, and registers storing count information. For example, the registers may store CPU_CYCLE, INST_RETIRED, L3D_CACHE, L3D_CACHE_REFILL, STALL_BACKEND_MEM, L2D_CACHE_REFILL, L3D_CACHE_REFILL, L2 PREFETCH REFILL, L3D_CACHE_REFILL_RD, LL_Cache_Rd, and LL_Cache_Miss_Rd. As illustrated in FIG. 5C, a BTMU may monitor traffic of a bus connected to a CPU.

FIG. 6 is a diagram illustrating an MH-DVFS operation according to an example embodiment of the present disclosure. An MH-DVFS may collect microarchitecture information from an AMU. The microarchitecture information may be an IPC (the number of instructions processed by a CPU per cycle, CNT1 in FIG. 2), MSPC (the number of times the CPU is in a memory stall state per cycle, CNT2 in FIG. 2).

When the IPC is low and the MSPC is high (that is, when more time is required or desired for the CPU to stand by due to a memory stall than to process an instruction), the MH-DVFS may decrease a CPU frequency through a CPU DVFS manager, thereby reducing unnecessary CPU power consumption.

In general, the memory stall may be more affected by an outer cache positioned closer to the CPU than a memory positioned farther away from the CPU. Accordingly, when the MSPC is high (that is, the CPU is frequently in a standby state due to the memory stall), a bottleneck delaying data fetching may be highly likely to be in the outer cache. Accordingly, when the MSPC is high, the MH-DVFS may increase an operating frequency of the outer cache through an OC DVFS manager. Thus, the memory stall may be resolved.

In addition, when the memory stall persists despite an increase in the frequency of the outer cache, the bottleneck may be highly likely to be in the memory, not the outer cache. When the high MSPC persists for more than a predetermined (or alternatively, desired) period of time, the MH-DVFS may increase the memory operating frequency through the MEM DVFS manager. Thus, the memory stall may be resolved.

In an example embodiment, the MH-DVFS may change a frequency (for example, freq_CPU) of an inner cache memory using the microarchitecture information. In an example embodiment, the MH-DVFS may control a first manager determining a frequency (freq_CPU) of the CPU using the microarchitecture information, a second manager determining a frequency (freq_OC) of a cache memory using the microarchitecture information, and a third manager determining a frequency (freq_MEM) of a memory interface circuit using the microarchitecture information. In an example embodiment, an execution order of the first manager, the second manager, and the third manager may be determined depending on the microarchitecture information. In an example embodiment, the MH-DVFS may determine a memory hierarchy in which a memory stall occurs using the microarchitecture information, and may increase a corresponding frequency when the determined memory hierarchy is accessed so as to solve a bottleneck.

In summary, the MH-DVFS may verify a frequency of the memory stall based on the IPC and MSPC collected through the AMU. When the memory stall frequency is high, the MH-DVFS may first increase the frequency of the outer cache. When the memory stall persists despite an increase in the frequency of the outer cache, the memory stall may be rapidly resolved through a hierarchical DVFS method of increasing the frequency of the memory. In addition, when actual instruction processing time is shorter than CPU execution time, the MH-DVFS may reduce unnecessary power consumption by decreasing a frequency of the CPU.

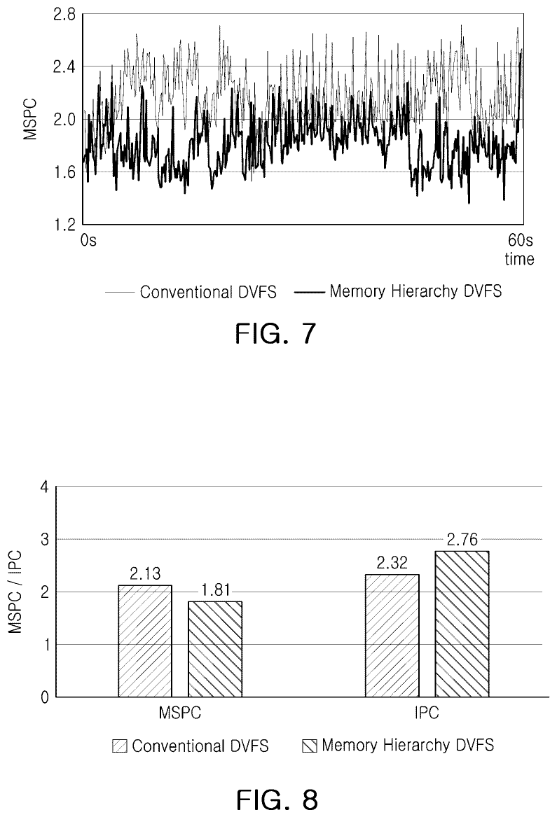

FIG. 7 is a diagram illustrating a result of comparing a conventional DVFS method with an MH-DVFS according to some example embodiments of the present disclosure with respect to a web browsing scenario. First of all, referring to the trend of an MSPC, the overall MSPC may be lowered, and the range of phase change may become smaller when the MSPC instantaneously fluctuates. The MH-DVFS according to some example embodiments of the present disclosure may resolve a memory stall more rapidly than the conventional DVFS method.

FIG. 8 is a diagram illustrating a comparison between average values of an MSPC and an IPC of a processor according to an example embodiment of the present disclosure. Referring to FIG. 8, the MSPC may decrease by 18% (2.13→1.81), and the IPC may increase by 16% (2.32→2.76). It may be interpreted that the number of instructions processed by the CPU increases due to rapid resolution of a memory stall. That is, rapid memory stall resolution may lead to improvement in CPU performance.

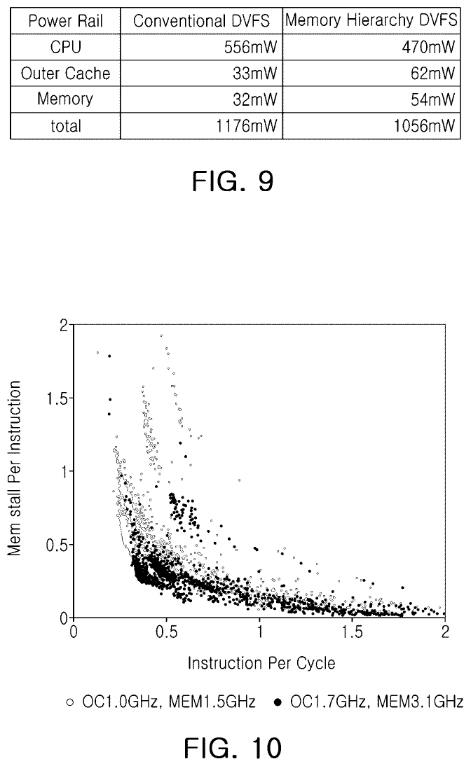

FIG. 9 is a diagram illustrating a comparison in power consumption of a processor according to an example embodiment of the present disclosure. Referring to FIG. 9, in terms of power consumption, the power consumption of an outer cache and a memory may be nearly doubled due to an increase in frequency. Conversely, the power consumption of a CPU may decrease, and the total power consumption may decrease by 11% (1176 mW→1056 mW). When an IPC is low and an MSPC is high, the effect of an MH-DVFS lowering a CPU frequency and rapid memory stall resolution may reduce CPU execution time, and accordingly the frequency may be decreased, resulting in a decrease in the power consumption of the CPU.

In a general DVFS method, a load may be computed by decoupling a memory stall cycle during a CPU execution cycle, and thus more accurate DVFS may be performed. As a result, the general DVFS method may remove unnecessary CPU power consumption by removing a portion occupied by a memory stall from a CPU load. The general DVFS method may reduce CPU power consumption by decoupling the memory stall from the CPU load to lower a CPU frequency, but is silent on a method of solving the memory stall. Conversely, an MH-DVFS method according to some example embodiments of the present disclosure may rapidly resolve the memory stall, thereby reducing overall power consumption.

FIG. 10 is an example diagram illustrating distribution of an MPI depending on an IPC in a web browsing scenario. Referring to FIG. 10, a cluster may be formed in a low IPC-high MPI period. That is, when the IPC is generally low, a memory stall may be high.

Due to an increase in frequencies of an OC and an MEM, a cluster of low IPCs may be downwards (an increase in IPC and a decrease in MSPC). There is no significant change in a high IPC region, which may lead to expectation of CPU power consumption by a reduced memory stall rather than improvement in UX performance by a resolved memory stall.

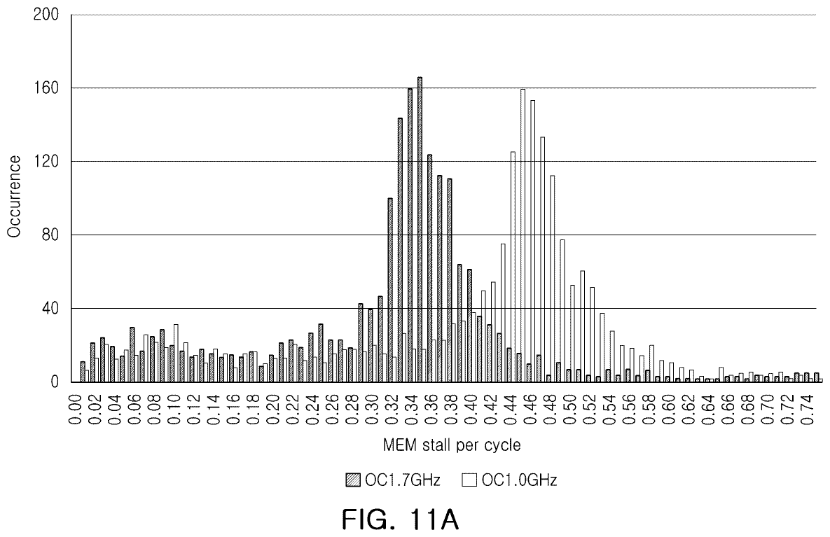

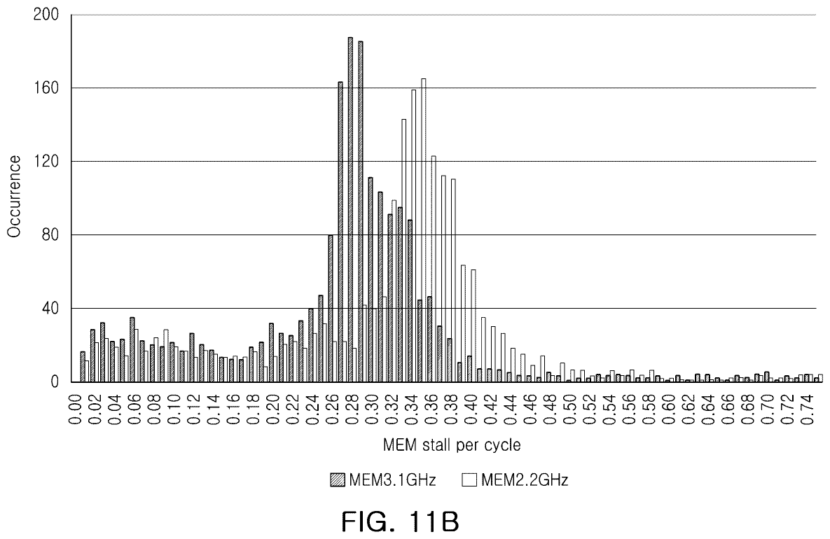

FIG. 11A is a diagram illustrating a memory stall per cycle depending on a frequency of an OC, and FIG. 11B is a diagram illustrating a memory stall per cycle depending on a frequency of a MEM. Referring to FIG. 11A, a change in a histogram of an MSPC depending on an OC/MEM frequency is illustrated. A latency band (a region in which occurrences are concentrated) may be formed depending on a frequency condition. As the frequency increases, the latency band may move to the left. The latency band may be formed by memory structural latency (latency that is consumable during memory structural access, which may be a minimum latency that is only consumable during memory structural access).

On the memory hierarchy, each hierarchy may have structural latency and a latency band, thereby classifying a layer causing a memory stall. A left side of the latency band may be classified as OC access, and the rest including the latency band may be classified as memory access. The latency band may be affected by both OC and MEM frequencies. This may be because it goes through the OC during memory access. In order to resolve a memory stall of an upper memory hierarchy, it may be necessary to increase a frequency of a lower hierarchy as well as the corresponding hierarchy.

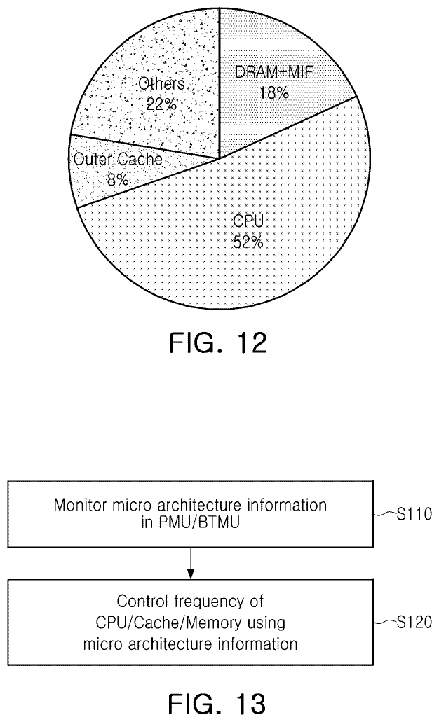

FIG. 12 is an example diagram illustrating a current consumption proportion occupied by each of a CPU and a memory hierarchy in a web browsing scenario. Referring to FIG. 12, in general, the CPU may consume significantly more power than the memory hierarchy. Thus, even when power increases due to an increase in frequency of the memory hierarchy, CPU power may be reduced due to a reduction in CPU memory stalls, leading to an overall energy reduction.

FIG. 13 is an example diagram illustrating a method of operating the processor 100 according to an example embodiment of the present disclosure. Referring to FIGS. 1 to 13, the method of operating the processor 100 may proceed as follows. The processor 100 may monitor microarchitecture information INT_ARC from a PMU/BTMU (S110). The processor 100 may control a frequency of a CPU/cache/memory using the microarchitecture information INT_ARC (S120).

In an example embodiment, the processor 100 may acquire the microarchitecture information INT_ARC by counting a first count value CNT1 of executing, by the CPU, an instruction per cycle (see FIG. 2) or counting a second count value CNT2 for a memory stall of the CPU per cycle (see FIG. 2). In an example embodiment, a frequency of the cache may be increased using the first count value CNT1 and the second count value CNT2. In an example embodiment, after the frequency of the cache is increased, a frequency of the memory may be increased in a stepwise manner using the first count value CNT1 and the second count value CNT2.

An MH-DVFS method according to some example embodiments of the present disclosure may operate in consideration of a processor.

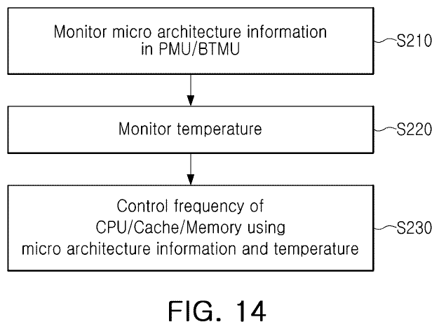

FIG. 14 is an example diagram illustrating a method of operating the processor 100 according to another example embodiment of the present disclosure. Referring to FIGS. 1 to 14, the processor 100 may operate as follows. The processor 100 may monitor the microarchitecture information INT_ARC from a PMU/BTMU (S210). The processor 100 may monitor internal temperature (S220). The processor 100 may control a frequency of a CPU/cache/memory using the microarchitecture information INT_ARC and the temperature (S230).

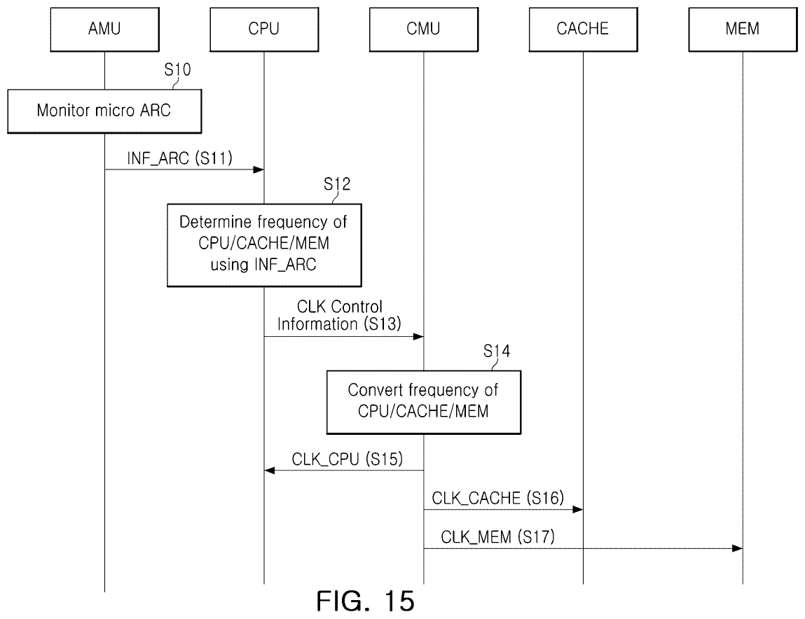

FIG. 15 is a ladder diagram illustrating an operation of an electronic device according to an example embodiment of the present disclosure. Referring to FIGS. 1 to 15, the electronic device 10 may manage a frequency of a clock as follows.

A PMU/BTMU may monitor INF_ARC related to a CPU (S10). The CPU may receive the INF_ARC from the PMU/BTMU (S11). The CPU may determine an optimal frequency of a CPU/CACHE/MEM using the INF_ARC for power consumption and performance through MH-DVFS (S12). The CPU may transmit clock control information corresponding to the optimal frequency to a CMU (S13). The CMU may change the frequency of the CPU/CACHE/MEM in response to the clock control information (S14). The CPU may receive a clock CLK_CPU depending on the changed CPU frequency (S15). The CACHE may receive a clock CLK_CACHE depending on the changed CACHE frequency (S16). The MEM may receive a clock CLK_MEM depending on the changed MEM frequency (S17).

Some example embodiments of the present disclosure may be applicable to a multi-core system.

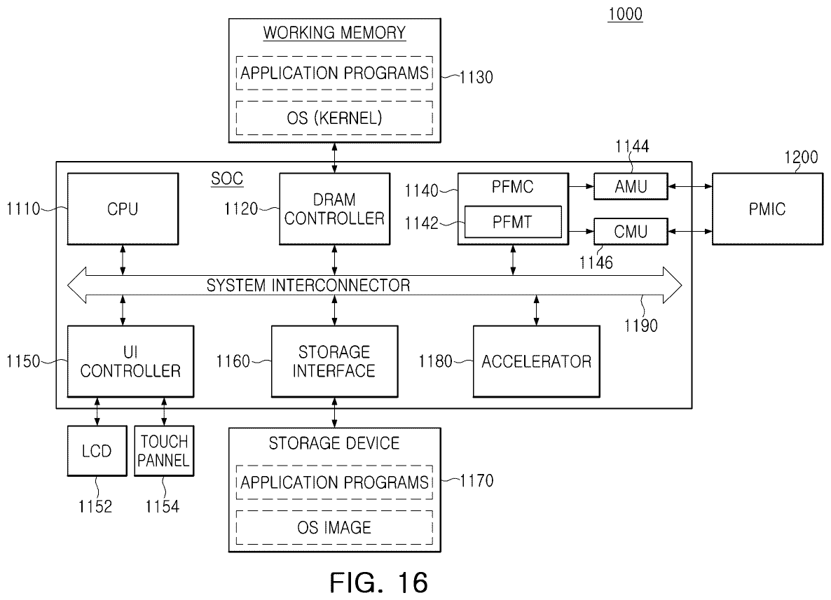

FIG. 16 is a ladder diagram illustrating a multi-core system 1000 according to an example embodiment of the present disclosure. Referring to FIG. 16, the multi-core system 1000 may include an SoC, a working memory 1130, a display device (LCD) 1152, a touch panel 1154, a storage device 1170, and a PMIC 1200. The SoC may include a processor (CPU) 1110, a DRAM controller 1120, a performance controller 1140, an AMU 1144, a CMU 1146, a user interface controller 1150, a memory interface circuit 1160, and an accelerator 1180. It should be understood that the components of the multi-core system 1000 are not limited to the illustrated components. For example, the multi-core system 1000 may further include a hardware codec, a security block, and the like for processing image data.

The processor 1110 may execute software (application programs, operating systems, device drivers) to be executed in the multi-core system 1000. The processor 1110 may execute an operating system (OS) loaded into the working memory 1130. In addition, the processor 1110 may execute various application programs to be driven based on the OS. The processor 1110 may be provided as a homogeneous multi-core processor or a heterogeneous multi-core processor. The multi-core processor may be a computing component having at least two independently drivable processor cores (hereinafter, cores). Each (or alternatively, at least one) of the cores may read and execute program instructions independently.

Each of (or alternatively, at least one) multi-cores of the processor 1110 may include a plurality of power domains operated by an independent driving clock and an independent driving voltage. In addition, a driving voltage and a driving clock signal supplied to each of (or alternatively, at least one) the multi-cores may be blocked or connected in units of cores. Blocking a driving voltage and a clock signal provided to each power domain from a specific core may be referred to as hotplug-out, and providing a driving voltage and a clock to the specific core may be referred to as hotplug-in. In addition, a frequency of a driving clock and a level of a driving voltage provided to each power domain may vary depending on a load processed by each of (or alternatively, at least one) the cores. That is, each core may be controlled by a DVFS method in which a frequency of a driving clock or a level of a driving voltage provided to a corresponding power domain are increased as time required (or alternatively, desired) to process tasks increases. The hot plug-in and hot plug-out may be performed with reference to a driving voltage and an operating frequency of a driving clock of the processor 1110 adjusted through the DVFS method.

In order to control the processor 1110 in such a manner, a kernel of the OS may monitor the number of tasks in a run queue, and the driving voltage and the driving clock of the processor 1110 at specific time intervals. In addition, the kernel of the OS may control hot plug-in or hot plug-out of the processor 1110 with reference to monitored information.

The DRAM controller 1120 may provide interfacing between the working memory 1130 and the SoC. The DRAM controller 1120 may access the working memory 1130 in response to a request from the processor 1110 or another functional block (IP). For example, the DRAM controller 1120 may write data in the working memory 1130 in response to a write request from the processor 1110. Alternatively, the DRAM controller 1120 may read out data from the working memory 1130 in response to a read request from the processor 1110 to transmit the data to the processor 1110 or the memory interface circuit 1160 through a data bus.

The OS or basic application programs may be loaded into the working memory 1130 during booting. For example, when the multi-core system 1000 is booted, an OS image stored in the storage device 1170 may be loaded into the working memory 1130 based on a booting sequence. All input/output operations of the multi-core system 1000 may be supported by the OS. Similarly, application programs may be loaded into the working memory 1130 to be selected by a user or to provide a basic service. The working memory 1130 may be used as a buffer memory for storing image data provided from an image sensor such as a camera. The working memory 1130 may be a volatile memory such as a static random access memory (SRAM) or DRAM, or a non-volatile memory such as a PRAM, MRAM, ReRAM, FRAM, or NOR flash memory.

The performance controller 1140 may adjust operating parameters of the SoC in response to a control request provided from the kernel of the OS. For example, the performance controller 1140 may adjust a level of DVFS so as to increase the performance of the SoC. Alternatively, the performance controller 1140 may control a driving mode of a multi-core processor such as Big.LITTLE of the processor 1110 in response to a request from the kernel. In this case, the performance controller 1140 may include a performance table 1142 for setting a driving voltage and an operating frequency of a driving clock therein. The performance controller 1140 may control the AMU 1144 and the CMU 1146 connected to the PMIC 1200 to provide a driving voltage and a driving clock specified for each power domain.

The user interface controller 1150 may control user input and output from user interface devices. For example, the user interface controller 1150 may display a keyboard screen for inputting data to a liquid crystal display 152 under the control of the processor 1110. In addition, the user interface controller 1150 may control the display device 1152 to display data requested by the user. The user interface controller 1150 may decode data provided from a user input means such as a touch panel 1154 into user input data.

The storage interface circuit 1160 may access the storage device 1170 in response to the request from the processor 1110. That is, the storage interface circuit 1160 may provide an interface between the SoC and the storage device 1170. Data processed by the processor 1110 may be stored in the storage device 1170 through the storage interface circuit 1160, and the data stored in the storage device 1170 may be stored in the processor 1110 through the storage interface circuit 1160.

The storage device 1170 may be provided as a storage medium of the multi-core system 1000. The storage device 1170 may store application programs, an OS image, and various pieces of data. The storage device 1170 may be provided as a memory card (MMC, eMMC, SD, MicroSD, or the like). The storage device 1170 may include a NAND flash memory having a large storage capacity. Alternatively, the storage device 1170 may include a next-generation non-volatile memory such as a PRAM, MRAM, ReRAM, and FRAM, or a NOR flash memory. In another example embodiment of the present disclosure, the storage device 1170 may be a built-in memory provided within the SoC.

The accelerator 1180 may be provided as a functional block (IP) for improving processing speed of multimedia or multimedia data. For example, the accelerator 1180 may be provided as a functional block (IP) for improving processing performance of text, audio, still images, animation, video, two-dimensional data, or three-dimensional data.

The system interconnect 1190 is a system bus for providing an on-chip network from within the SoC. The system interconnect 1190 may include, for example, a data bus, an address bus, and a control bus. The data bus may be a path through which data travels. In general, the data bus may be provided as a memory access path to the working memory 1130 or the storage device 1170. The address bus may provide an address exchange path between functional blocks (IPs). The control bus may provide a path for transmitting control signals between the functional blocks (IPs). However, a configuration of the system interconnector 1190 is not limited to the above description, and may further include mediation means for efficient management.

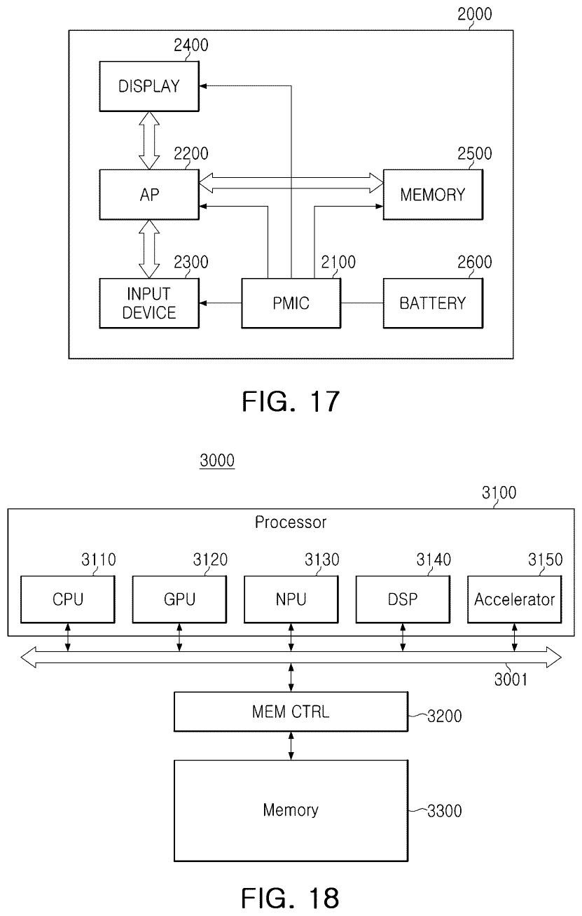

FIG. 17 is a diagram illustrating an electronic device 2000 according to an example embodiment of the present disclosure. Referring to FIG. 17, the electronic device 2000 may include a PMIC 2100, an application processor (AP) 2200, an input device 2300, a display device 2400, a memory device. 2500, and a battery 2600.

The PMIC 2100 may receive power from the battery 2600, and may supply the power to the AP 2200, the input device 2300, the display device 2400, or the memory device 2500 and manage the power of the AP 2200, the input device 2300, the display device 2400, or the memory device 2500. The electronic device 2000 may include at least one PMIC 2100. In an example embodiment, the electronic device 2000 may supply power to the AP 2200, the input device 2300, the display device 2400, or the memory device 2500 using one PMIC 2100. In another example embodiment, the electronic device 2000 may include a plurality of PMICs 2100 for individually supplying power to each of (or alternatively, at least one) the AP 2200, the input device 2300, the display device 2400, or the memory device 2500.

The AP 2200 may control an overall operation of the electronic device 2000. For example, the AP 2200 may display data stored in the memory device 2500 through the display device 2400 in response to an input signal generated by the input device 2300. The input device 2300 may be implemented as a pointing device such as a touch pad or a computer mouse, a keypad, or a keyboard. As described with reference to FIGS. 1 to 16, the AP 2200 may monitor activity (performance/bottleneck) for each memory hierarchy by executing a DVFS module, and may change a frequency/voltage of a memory hierarchy depending on a monitoring result.

The memory device 2500 may be implemented to store various pieces of data used by at least one component of the electronic device 2000, for example, software and input data or output data on an instruction related thereto. The memory device 2500 may include a volatile memory or a non-volatile memory. In an example embodiment, the memory device 2500 may store information on task execution conditions corresponding to various tasks. For example, the electronic device 2000 may store a task execution condition corresponding to each user identification information. The memory device 2500 may store load control information for various operations of the electronic device 2000.

The battery 2600 may be implemented as a rechargeable secondary battery. For example, the battery 2600 may be charged using power received through an interface circuit or power received through a wireless charging module.

The interface circuit may be connected to an external power source in a wired manner, thereby transmitting power from the external power source to the PMIC 2100. The interface circuit may be implemented as a connector for connecting a cable for providing power or as a cable for providing power and a connector for connecting the cable to the external power source. For example, the interface circuit may be implemented as various USB-type connectors. However, it should be understood that a type of connector is not limited. When DC power is received from the external power source, the interface circuit may transmit the received DC power to the PMIC 2100, or may convert a voltage level of the received DC power and transmit the DC power having the converted voltage level to the PMIC 2100. Conversely, when AC power is received from the external power source, the interface circuit may convert the AC power into DC power and transmit the DC power to the PMIC 2100, or may convert a voltage level of the AC power and transmit the AC power having the converted voltage level to the PMIC 2100.

The wireless charging module may be implemented through a method defined in the wireless power consortium (WPC) standard (or Qi standard) or a method defined in the alliance for wireless power (A4WP) standard (or air fuel alliance (AFA) standard). The wireless charging module may include a coil in which an induced electromotive force is generated by a magnetic field having a size changing depending on time formed therearound. The wireless charging module may include at least one of a coil for reception, at least one capacitor, an impedance matching circuit, a rectifier, a DC-DC converter, or a communication circuit. The communication circuit may be implemented as an in-band communication circuit using an ON/OFF keying modulation/demodulation method, or may be implemented as an out-of-band communication circuit (for example, a BLE communication module). In various example embodiments, the wireless charging module may receive, based on an RF method, a beam-formed radio frequency (RF) wave.

In an example embodiment, the interface circuit or the wireless charging module may be connected to a charger. The battery 2600 may be charged using power adjusted by the charger. The charger or converter may be implemented as an element independent from the PMIC 2100, or may be implemented as at least a part of the PMIC 2100. The battery 2600 may transmit stored power to the PMIC 2100. Power through the interface circuit or power through the wireless charging module may be transmitted to the battery 2600 or may be transmitted to the PMIC 2100.

Some example embodiments of the present disclosure may be applicable to a neural network computing system.

FIG. 18 is a diagram illustrating a neural network computing system 3000 according to an example embodiment of the present disclosure. Referring to FIG. 18, the neural network computing system 3000 may execute a neural network model. The neural network model, a model of a learning method in which the human brain processes information, may refer to a model capable of accurately recognizing and determining an object or specific information from various pieces of user data such as voice audio, an image, and a video.

The neural network computing system 3000 may be a system such as a mobile phone, a smart phone, a tablet personal computer, a wearable device, a healthcare device, or an Internet of things (IoT) device. However, the neural network computing system 3000 is not necessarily limited to a mobile system, and may be a personal computer, a laptop computer, a server, a media player, or an automotive device such as a navigation system.

The neural network computing system 3000 may include a system bus 3001, a processor 3100, a memory controller 3200, and a memory device 3300. The system bus 3001 may support communication between the processor 3100, the memory controller 3200, and the memory device 3300.

The processor 3100 may perform neural network computation using data stored in the memory device 3300. For example, the neural network computation may include an operation of reading data and a weight for each node included in the neural network model, performing convolution computation on the data and weight, and storing or outputting a result of the computation.

The memory device 3300 may store data necessary for the processor 3100 to perform neural network computation. For example, one or more neural network models executable by the processor 3100 may be loaded into the memory device 3300. In addition, the memory device 3300 may store input data and output data of the neural network model. The memory device 3300 may include a volatile memory such as a DRAM, SDRAM, SRAM, RRAM, or the like, and may include a non-volatile memory such as a flash memory.

The memory controller 3200 may control an operation of storing data received from the processor 3100 in the memory device 3300 and an operation of outputting data stored in the memory device 3300 to the processor 3100.

The processor 3100 may include heterogeneous computing devices performing data processing or computation, such as a CPU 3110, a graphic processing unit (GPU) 3120, a neural processing unit (NPU) 3130, a digital signal processor (DSP) 3140, an accelerator 3150, and the like. Specifically, the CPU 3110 may be a highly versatile computing device. The GPU 3120 may be a computing device optimized (or alternatively, improved) for parallel computation such as graphics processing. The NPU 3130, a computing device optimized (or alternatively, improved) for neural network computation, may include logical blocks for executing unit computation mainly used for neural network computation, such as convolution computation. The DSP 3140 may be a computing device optimized (or alternatively, improved) for real-time digital processing of an analog signal. In addition, the accelerator 3150 may be a computing device for rapidly performing a specific function.

When the processor 3100 executes the neural network model, various hardware devices may operate together. For example, in order to execute the neural network model, not only the NPU 3130 but also heterogeneous computing devices such as the CPU 3110 and the GPU 3120 may operate together. In addition, the memory controller 3200 and the data bus 3001 may operate so as to read input data of the neural network model and store output data.

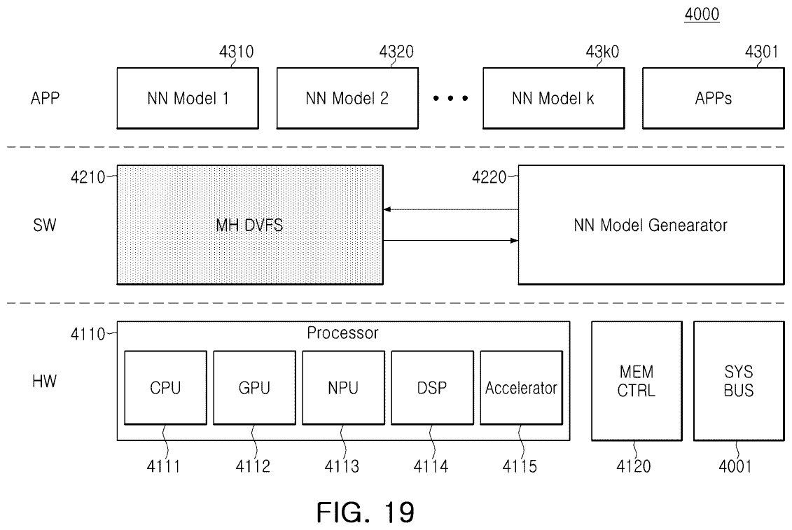

FIG. 19 is an example diagram illustrating a hierarchical structure of a neural network computing system according to an example embodiment of the present disclosure. Referring to FIG. 19, a neural network computing system 4000 may include a hardware hierarchy HW, a system software hierarchy SW, and an application hierarchy APP.

The hardware hierarchy HW, a lowest hierarchy of the neural network computing system 4000, may include hardware devices such as a system bus 4001, a processor 4110, and a memory controller 4120. The processor 4110 may include heterogeneous computing devices, for example, a CPU 4111, a GPU 4112, an NPU 4113, a DSP 4114, and another accelerator 4115.

The system software hierarchy SW may manage hardware devices of the hardware hierarchy HW and provide an abstracted platform. For example, the system software hierarchy SW may drive a kernel such as Linux.

The system software hierarchy SW may include an MH-DVFS 4210 and a neural network model executor 4220. The MH-DVFS 4210 may determine operating frequencies of hardware devices for each memory hierarchy using microarchitecture information.

The neural network model executor 4220 may execute the neural network model using hardware devices operating at an operating frequency determined by the MH-DVFS 4210. In addition, the neural network model executor 4220 may output actual execution time of the neural network model as a result of executing the neural network model.

In addition, the system software hierarchy SW may be driven by the processor 4110. For example, the system software hierarchy SW may be driven by the CPU 4111. However, it should be understood that a computing device in which the system software hierarchy SW is drivable is not limited to the CPU 4111.

The application hierarchy APP may be executed on the system software hierarchy SW, and may include a plurality of neural network models 4310 to 43k0 (where k is an integer greater than or equal to 2) and other applications 4301. For example, the other applications 4301 may include a camera application. The plurality of neural network models 4310 to 43k0 may include a model for detecting an object included in an image frame acquired by a camera application, a model for identifying the detected object, a model for detecting a target region in the image frame, a model for identifying the detected target region, a model for classifying the identified target regions to correspond to meanings such as people, motor vehicles, and trees, and the like. However, it should be understood that types of neural network models and other applications are not limited thereto.

When the neural network model is executed, the other applications may be simultaneously (or alternatively, contemporaneously) executed, and the plurality of neural network models may be simultaneously (or alternatively, contemporaneously) executed. For example, when the neural network computing system 4000 is a mobile system, a neural network model for detecting an object may be executed simultaneously (or alternatively, contemporaneously) with the execution of the camera application. When a plurality of applications, including the neural network model, are simultaneously (or alternatively, contemporaneously) executed, resource competition may occur in the hardware devices.

The processor according to an example embodiment of the present disclosure may include a module A periodically monitoring microarchitecture information (uarch information) and a module B determining, based on the monitored uarch information, a frequency of a CPU/cache/memory. In an example embodiment, the module A may monitor the number of instructions processed by the CPU and the number of memory stalls during a given cycle. In an example embodiment, when the number of memory stalls is less than or equal to a predetermined (or alternatively, desired) number and the number of instructions processed is less than or equal to a predetermined (or alternatively, desired) number, the module B may limit the frequency of the CPU. A level of the limited frequency may be proportional to or otherwise based on at least one of the number of memory stalls and the number of instructions processed. In an example embodiment, the module B may distinguish, based on the number of memory stalls, a layer in which a memory stall occurs. In an example embodiment, when a memory stall occurs, module B may increase a frequency of a layer affecting the occurrence of the memory stall within the memory hierarchy. Here, the increased frequency may be increased in proportion to the number of memory stalls or may be determined by a combination for achieving lowest energy.

According to some example embodiments of the present disclosure, an activity of each of (or alternatively, at least one) a plurality of memory channels may be monitored, and a frequency of a memory device corresponding to a memory channel in which a bottleneck occurs may vary in real time or on the fly.

Any of the elements and/or functional blocks disclosed above may include or be implemented in processing circuitry such as hardware including logic circuits; a hardware/software combination such as a processor executing software; or a combination thereof. For example, AMU 140, the DVFS Governor Module 114-1, BTMU, CMU Device Driver 114-2, PMIC device driver 114-3, core 112, MIF 130, PMU 110, AP 2200, NPU 3130 and accelerator 3150. may be implemented as processing circuitry. The processing circuitry specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Processor(s), controller(s), and/or processing circuitry may be configured to perform actions or steps by being specifically programmed to perform those action or steps (such as with an FPGA or ASIC) or may be configured to perform actions or steps by executing instructions received from a memory, or a combination thereof.

While example embodiments have been shown and described above, it will be apparent to those skilled in the art that modifications and variations could be made without departing from the scope of the example embodiments of the present disclosure as defined by the appended claims.

1. A processor comprising:
a central processing unit (CPU) configured to drive a dynamic voltage and frequency scaling (DVFS) module;
a memory hierarchy configured to store data for an operation of the CPU; and
an activity monitoring unit (AMU) configured to generate microarchitecture information by monitoring performance of the CPU or monitoring traffic of a system bus connected to the memory hierarchy,
wherein the DVFS module is configured to determine a layer within the memory hierarchy in which a memory stall occurs using the microarchitecture information, and to increase a frequency in response to the determined layer being accessed.

2. The processor of claim 1, wherein the AMU includes:
a performance monitoring unit configured to monitor the performance of the CPU; or
a bus traffic monitoring circuit configured to monitor the traffic of the system bus.

3. The processor of claim 2, wherein the performance monitoring unit is configured to:
count a number of instructions processed by the CPU per cycle; or
count a number of memory stalls of the CPU per cycle.

4. The processor of claim 3, wherein the DVFS module is configured to limit a frequency of the CPU when the number of instructions is less than or equal to a first reference value or the number of memory stalls is less than or equal to a second reference value.

5. The processor of claim 4, wherein a magnitude of the frequency of the CPU is based on the number of instructions and the number of memory stalls.

6. The processor of claim 3, wherein the DVFS module is configured to determine the layer within the memory hierarchy in which the memory stall occurs using the number of memory stalls.

7. The processor of claim 1, wherein the DVFS module is configured to determine the frequency so as to increase the frequency or reduce power consumption based on to a number of memory stalls.

8. The processor of claim 1, wherein the memory hierarchy includes:
a cache memory configured to temporarily store the data for the operation of the CPU; and
a memory interface circuit configured to transmit data of the cache memory to a memory device through the system bus.

9. The processor of claim 8, wherein the DVFS module is configured to determine to increase a frequency of the cache memory, when the microarchitecture information indicates that a number of memory stalls per cycle is greater than or equal to a reference value.

10. The processor of claim 9, wherein the DVFS module is configured to determine to increase a frequency of the memory interface circuit, in response to the number of memory stalls per cycle being greater than or equal to the reference value even with the frequency of the cache memory being increased.

11. A method of operating a processor, the method comprising:
monitoring, by a performance monitoring unit or a bus traffic monitoring unit, microarchitecture information;
controlling frequencies of a CPU, a cache memory, or a memory device using the microarchitecture information;
monitoring, by the performance monitoring unit, performance of the CPU; and
monitoring, by the bus traffic monitoring unit, traffic of a system bus between the cache memory and the memory device.

12. The method of claim 11, wherein the monitoring the microarchitecture information includes:
counting a first count value of executing instructions per cycle by the CPU; and
counting a second count value for memory stalls of the CPU per cycle.

13. The method of claim 12, further comprising:
increasing a frequency of the cache memory based on the first count value and the second count value.

14. The method of claim 12, comprising:
after increasing a frequency of the cache memory, increasing a frequency of the memory device based on the first count value and the second count value.

15. The method of claim 11, further comprising:
monitoring a temperature of the processor; and
controlling a frequency among the frequencies of at least one of the CPU, the cache memory, and the memory device using the temperature.

16. An electronic device comprising:
a processor; and
a memory device connected to the processor;
wherein the processor includes
at least one central processing unit (CPU) configured to drive a dynamic voltage and frequency scaling (DVFS) module,
a cache memory configured to temporarily store data for an operation of the at least one CPU,
a memory interface circuit configured to transmit data of the cache memory to the memory device through a system bus, and
an activity monitoring unit (AMU) configured to monitor performance of the at least one CPU, or monitor traffic of the system bus,
wherein the DVFS module is configured to
collect microarchitecture information from the AMU; and
control a frequency of at least one of the at least one CPU, the cache memory, and the memory interface circuit using the microarchitecture information.

17. The electronic device of claim 16, wherein
the at least one CPU includes an internal cache memory, and
the DVFS module is configured to change a frequency of the internal cache memory using the microarchitecture information.

18. The electronic device of claim 16, wherein the DVFS module includes:
a first manager configured to determine a frequency of the at least one CPU using the microarchitecture information;
a second manager configured to determine a frequency of the cache memory using the microarchitecture information; and
a third manager configured to determine a frequency of the memory interface circuit using the microarchitecture information.

19. The electronic device of claim 18, wherein an execution order of the first manager, the second manager, and the third manager is determined depending on the microarchitecture information.

20. The electronic device of claim 16, wherein the DVFS module is configured to:
determine a memory hierarchy in which a memory stall occurs based on the microarchitecture information; and
increase a corresponding frequency in response to the determined memory hierarchy being accessed.

21-30. (canceled)
